(19) United States
(12) Patent Application Publication
(10) Pub. No.: US 2003/0032512 A1
(43) Pub. Date: Feb. 13, 2003

(54) Chain driving means of round shaped stick

(75) Inventor: Oe Sook Park, Pusan (KR)

Correspondence Address: GREENBLUM & BERNSTEIN, P.L.C., 1941 ROLAND CLARKE PLACE, RESTON, VA, 20191, US

(73) Assignee: FINE TECH CORPORATION of Jeonbuk, Republic of Korea

(21) Appl. No.: 10/167,696

(22) Filed: Jun. 13, 2002

(30) Foreign Application Priority Data
Jun. 14, 2001 (KR) 2001-17825

(51) Int. Cl. F16G 9/00; F16H 55/36; F16G 13/02

(52) U.S. Cl. 474/220; 474/237; 474/175

(57) ABSTRACT

This invention relates to a chain driving means of round shaped stick comprising a chain of round shaped stick and a chain sprocket which is mutually geared to chain driving means of round shaped stick for its driving force, thus ensuring better durability and tensile strength.

The chain driving means 1 of this invention comprises the link material 2a of round shaped stick instead of the conventional plate-shaped link material, which is connected to the axial pin 6 continuously, and the stop groove portion 8 with several pitches, corresponding to the link material 2a in a manner that the chain 2 of round shaped stick is mutually geared for its driving. With such structure, the chain driving means having better hardness and tensile strength may be extensively used as various driving means in the industrial fields and through the use of rodless cylinder for the efficient transportation of materials using an elevator or carrier for horizontal movement, while contributing much to the automation of production line distribution system.

### BACKGROUND OF THE INVENTION

### Field of the Invention

This invention relates to a chain driving means of round shaped stick and more particularly, to the chain driving means of round shaped stick comprising a chain of round shaped stick and a chain sprocket which is mutually geared to the chain driving means of round shaped stick for its driving force, thus ensuring better durability and tensile strength. In particular, this invention is mainly intended for providing the chain driving means of round shaped stick with better physical properties by directly connecting to various pistons, such as elevator and carrier, for horizontal movement using rodless cylinder, for the transportation of materials in the industrial fields.

Generally, the chain driving means applicable to the power transmission system is composed of a chain and a chain sprocket.

The caterpillar-shaped chain form is formed by continuously connecting a plate-shaped link of axial hole with axial pin, together with some adjacent links at the front and rear, while the chain sprocket, which is geared to the chain for its driving, has a mountain-shaped teeth portion in which a stop hole formed at front and rear link can be operated.

The conventional chain driving means with a plate-processing link has proven to be inadequate, when used in the various industrial fields due to poor hardness and tensile strength.

In particular, since the chain is used for transportation equipments such as an elevator or carrier for horizontal movement involved in the transportation of materials in the industrial fields, its better hardness and tensile strength should be essentially required among other things. However, the conventional driving means, which is applied to these equipments, has been associated with more shortened life span or poor durability of these equipments. Thus, there is an urgent need for the development of efficient chain driving means with better physical properties.

### SUMMARY OF THE INVENTION

Therefore, an object of this invention is to provide a chain driving means with better hardness and tensile strength so as to replace the conventional chain driving means with that of this invention.

### BRIEF DESCRIPTION OF THE DRAWINGS

FIG. 1 is a sectional view of the whole structure showing one preferred embodiment of this invention.

FIG. 2 is an exploded perspective view showing the chain of round shaped stick of this invention.

FIG. 3 is an exploded perspective view showing the chain sprocket of this invention.

FIG. 4 is a section view showing the connection of this invention.

Explanation of the main codes represented in the drawings

| | | | |
|---|---|---|---|
| 1: | Chain driving means round shaped stick | 2: | Chain |
| 2: | Link material | 3: | Chain sprocket |
| 4, 5: | Connection axis portion | 4a, 5a: | Axial |
| | hole | | |
| 6: | Axial pin | 7: | Axis-receiving |
| | portion | | |
| 8: | Stop groove portion | | |

### DETAILED DESCRIPTION OF THE INVENTION

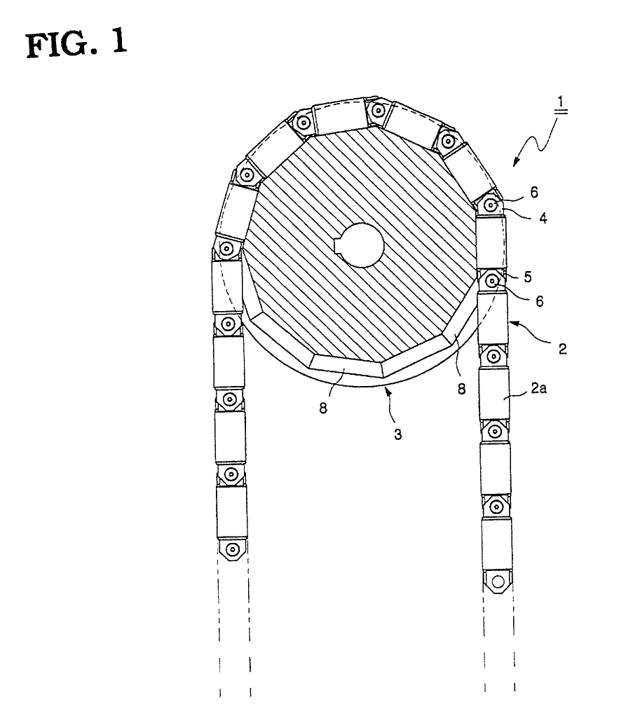

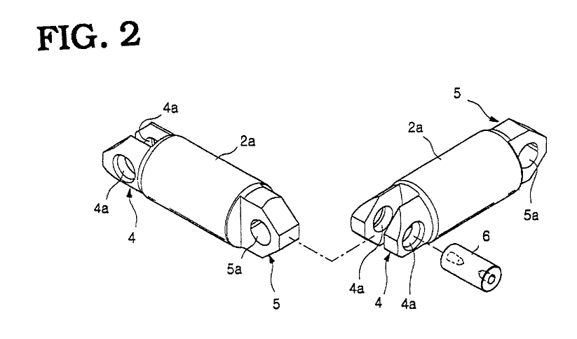

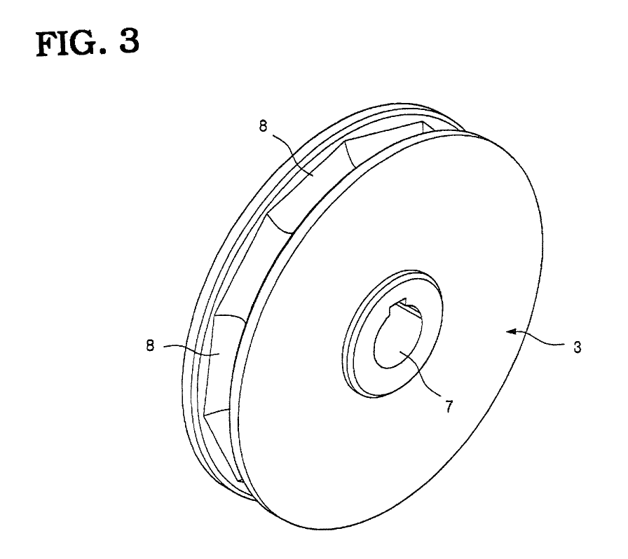

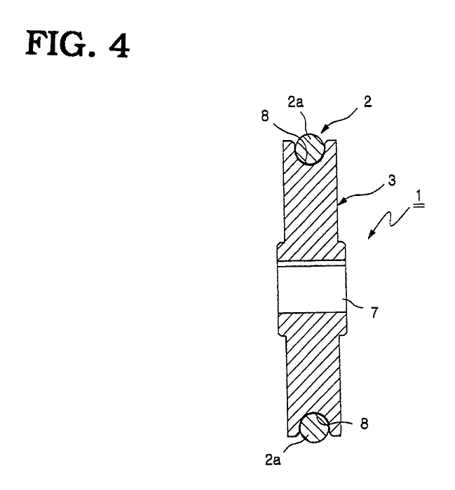

FIG. 1 is a sectional view of the whole structure showing one preferred embodiment of this invention FIGS. 2 and 3 are exploded perspective views showing the chain of round shaped stick 2 and chain sprocket 3, respectively, according to this invention. FIG. 4 is a section view showing the connection of this invention.

This invention is explained in detail by accompanying these drawings.

The chain driving means of round shaped stick 1 of this invention is characterized by the following structure:

The whole shape of the link material 2a has a round-shape stick using steel as a material of the chain 2. Each of connection axis portion 4, 5 is formed to adjust the angle of the link material 2a, which is continuously connected on either side.

Since the same link material 2a is continuously connected to the connection axis portions 4 and 5 on either side, one side of the link material 2a has a connection axis portion 4 with the axial hole 4a at its front and rear, while the other side of said link material 2a has the connection axis portion with the single hole 5a, corresponding to the axial hole 4a and both sides are axially connected by the axial pin 6. Thus, several pieces of the link material 2a are connected to the to the connection axis portions 4 and 5 in caterpillar or parallel form.

The chain sprocket 3 is geared to the chain 2 by the corresponding link material 2a of round-shaped stick. The chain 2 is driven by the rotary power transmitted from the chain sprocket 3, or inversely, to make the rotary driving of the chain sprocket 3 to the shuttle movement transmitted from the chain 2, the whole shape of the chain 2 is formed in an original pulley in a manner such that the axis-receiving portion 7 is formed in its center and the stop groove portion 8 to the link material 2a is formed with several pitches.

The stop groove portion 8 has a semicircle section with the same diameter as the link material 2a and its pitch is formed to the corresponding measurement of the link material 2a.

As such, the chain driving means 1 of this invention may extensively used for various equipments in the industrial fields, and its use for an elevator or carrier for horizontal movement which requires better hardness and tensile strength can ensure the most significant effect.

The chain driving means 1 of this invention is characterized by the following structure:

The chain sprocket 3 is axially formed in the chain driving means by the axis-receiving portion 7 by one or both sides. With its connection to a rotary driving means, such as motor, the chain sprocket 3 is formed in a manner that the chain 2 is connected in caterpillar form for the mutual gear driving; or, under the structure that one side of chain 2 is connected to a rodless cylinder and the other to an elevator, the chain sprocket 3, which is axially formed by the axis-receiving portion 7, is connected to the chain 2 for its mutual gear rotation.

With the chain 2 comprising each of link material 2a in round-shaped form, this invention also characterized in that when the chain 2 is in shuttle movement to the link material 2a or the chain sprocket 3 is in rotary driving, the mutually corresponding chain sprocket 3 and chain 2 can be in rotary or shuttle movement.

The chain 2 comprising each of link material 2a of round shaped stick has better hardness and tensile strength than the conventional plate-shaped link material on either side, while ensuring prolonged life span and efficient operation of various equipments.

As described above, The chain driving means 1 of this invention comprises the link material 2a of round shaped stick instead of the conventional plate-shaped link material, which is connected to the axial pin 6 continuously, and the stop groove portion 8 with several pitches, corresponding to the link material 2a in a manner that the chain 2 of round shaped stick is mutually geared for its driving. With such structure, the chain driving means having better hardness and tensile strength may be extensively used as various driving means in the industrial fields and through the use of rodless cylinder for the efficient transportation of materials using an elevator or carrier for horizontal movement, while contributing much to the automation of production line distribution system.

The present disclosure relates to subject matter contained in priority Korean Utility Model No. 2001-17825, filed on Jun. 14, 2001, the contents of which is herein expressly incorporated by reference in its entirety.

What is claimed is:

1. A chain driving means of round shaped stick having the chain 2 and chain sprocket 3, wherein it comprises:
the link material 2a of the chain 2 is a continuously connected link material 2 of round shaped stick from side to side;
one side of said link material 2a has a connection axis portion 4 with the axial hole 4a at its front and rear part, while the other side of said link material 2a has the connection axis portion with the single hole 5a, corresponding to said axial hole 4a and both sides are axially connected by the axial pin 6;
the axis-receiving portion 7 is formed in the center of said chain sprocket 3; and,
the outer portion of said chain sprocket 3 has several pieces of the stop groove portion 8 with pitch and semicircle section, corresponding to said link material 2a of round shaped stick.
